(19) United States
(12) Patent Application Publication
(10) Pub. No.: US 2002/0011689 A1
(43) Pub. Date: Jan. 31, 2002

(54) Method for manufacturing a keypad

(76) Inventors: Ching-Shou Chi, Shindian City (TW); Yang-Wei Wu, Taipei (TW); Hsi-Fu Chang, Shindian City (TW)

Correspondence Address: RABIN & CHAMPAGNE, PC, 1101 14TH STREET, NW, SUITE 500, WASHINGTON, DC, 20005, US

(21) Appl. No.: 09/755,040

(22) Filed: Jan. 8, 2001

(30) Foreign Application Priority Data
Jun. 21, 2000 (TW) 89112236

(51) Int. Cl. B29C 45/16

(52) U.S. Cl. 264/219; 264/246; 264/255; 425/130

(57) ABSTRACT

A method for manufacturing a keypad, where the key of the keypad has a key body and a three-dimensional character; the manufacturing method utilizes the female mold corresponding to the key and the male mold having three-dimensional character. The light-colored transparent material is made for key body with reserved space for three-dimensional character. The female mold having the key body is then combined with the another male mode. The dark-colored material is injected into the reserved space of the key body to form the three-dimensional character in the key body. Applying the color contrast between the textures of the key body and three-dimensional character, it enables to display the three-dimensional character shown in the key body.

### BACKGROUND OF THE INVENTION

This application incorporates by reference Taiwanese application Ser. No. 89112236, Filed Jun. 21, 2000.

1. Field of the Invention

The invention relates in general to a method for manufacturing a keypad, and more particularly to a method for manufacturing a keypad with the keys capable of showing the three-dimensional characters.

2. Description of the Related Art

With the rapid development of the computer and communication technologies, people nowadays living in the global village can communicate easily and conveniently by making a phone call or surfing the net through the computer system or communication system whenever they want, wherever they are. Keypad is an indispensable component of every input device, which has a number of keys represented Arabic numerals (0˜9), Roman numerals (I˜X), English alphabets (A˜Z), various symbols (#, *, +, / . . . ). letters or patterns illustrated some functions. It is easy to record the names, telephone numbers, dates and time schedule or make an operation as a calculator by utilizing the keypad. The keypad can match switches or membranes for using or combine with the conducted rubber for indirectly using to enhance the functions thereof.

The traditional method for manufacturing a keypad illuminated, either the color of the character is darker or lighter than the key body, is to print a character on the top or bottom surface of the key body. The ROC Patent Publication No. 285345 discloses that a character is printed on the bottom of the transparent key by opaque printing ink. Besides, the ROC Patent Publication No. 311229 discloses that the printing ink and paint are first printed on the surface of the transparent key and the light-permeable parts thereof are then scraped. Therefore, the illuminated keypad made by the conventional method does not have the keys capable of showing the three-dimensional characters.

### SUMMARY OF THE INVENTION

It is therefore an object of the invention to provide a method for manufacturing a keypad, where the key of the keypad has a three-dimensional character. Combined with an illuminant, the transparent key can show the three-dimensional character clearly and distinguishably utilizing the color contrast relation with light.

The invention achieves the above-identified objects by providing a method for manufacturing a keypad, where the key of the keypad has a key body and a three-dimensional character; the manufacturing process includes the female mold corresponding to the key is first made. The first male mold having the three-dimensional character and a second male mold corresponding to the key are then made. The female mold is combined with the first male mold and injected with a first material to form the key body, wherein the reserved space corresponding to the three-dimensional character is within the key body. The second male mold is combined with the female mold having the key body. The second material is then injected into the first reserved space to form the three-dimensional character, wherein the color contrast between the textures of the key body and three-dimensional character enables to display the three-dimensional character shown in the key body.

The invention achieves the above-identified objects by providing another method for manufacturing a keypad, where the key of the keypad has a key body and a three-dimensional character; the manufacturing process includes the first female mold corresponding to the key and the first male mold having three-dimensional character is first made. The first female mold is combined with the first male mold. The first material is injected into the room between the first female mold and the first male mold to form key body, wherein the reserved space corresponding to the three-dimensional character is within the key body. The second male mold and the second female mold corresponding to the three-dimensional character are then made and combined together. The second material is injected into the room between the second male mold and the second female mold to form three-dimensional character. The three-dimensional character is then embedded in the key body to form the key having three-dimensional character.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 shows a top view of a keypad according to the preferred embodiment of the invention;

FIG. 2 illustrates a flow chart of a method for manufacturing the keypad of FIG. 1;

FIG. 3A shows a female mold of manufacturing the keypad of FIG. 1;

FIG. 3B shows the first male mold of manufacturing keys with three-dimensional characters of the keypad of FIG. 1;

FIG. 3C shows the second male mold of manufacturing keys with three-dimensional characters of the keypad of FIG. 1;

FIGS. 4A-4D show cross-sectional views of the manufacturing process of the keypad of FIG. 1;

FIG. 4E shows a cross-sectional view of a key structure, which the top of the three-dimensional character connects, the bottom of the cavity;

FIGS. 5A, 5B, 5D and 5E shows cross-sectional views of another manufacturing process of the keypad of FIG. 1;

FIG. 5C illustrates a cross-sectional view of the key structure with the reserved space of FIG. 5B;

FIG. 5F shows a first male mold of manufacturing a keypad capable of disposed LED;

FIG. 5G shows a second male mold for manufacturing a keypad capable of disposed LED;

FIG. 6A shows another structural diagram of keys with three-dimensional characters of the keypad of FIG. 1;

FIG. 6B shows a second male mold of manufacturing keys with three-dimensional characters of the keypad of FIG. 6A;

FIGS. 6C-6D shows cross-sectional view of parts of the manufacturing process for making the keypad of FIG. 6A;

FIG. 6E shows a cross-sectional view of the key structure, which the reserved space is filled with the second material of FIG. 6C;

FIG. 7 illustrates a flow chart of another method for manufacturing the keypad of FIG. 1;

FIG. 8A shows a structural cross-sectional view of the second female mold of manufacturing three-dimensional characters;

FIG. 8B shows a structural cross-sectional view of the second male mold of manufacturing three-dimensional characters; and

FIGS. 8C-8F shows another cross-sectional view of parts of the manufacturing process for making the keypad of FIG. 7.

### DESCRIPTION OF THE PREFERRED EMBODIMENT

In the following preferred embodiment of the invention, the number (0˜9) keys, # key and * key of the keypad are taken for example. The keys of letters, symbols, numerals or function keys can be also placed instead for applying in different appliances so that the disclosure will be thorough and complete without departing the spirit and scope of this invention.

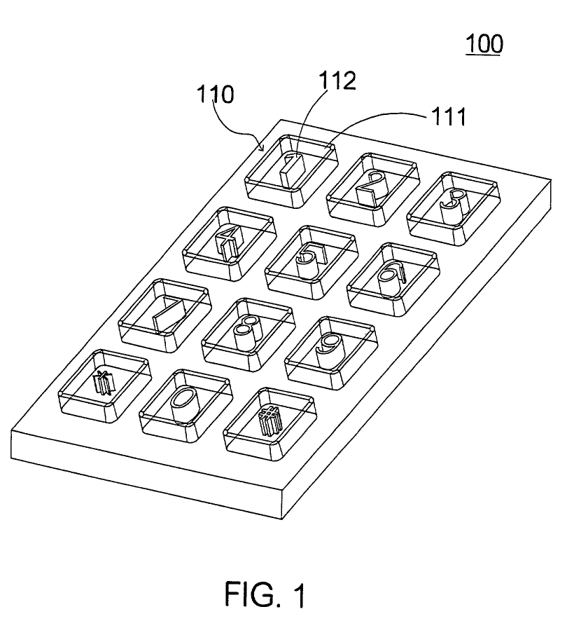

Referring first to FIG. 1, a top view of a keypad according to the preferred embodiment of the invention is shown. The keypad 100 includes a number of keys 110 such like the number keys 0˜9 and symbol keys #, * which are arranged in arrays with interval. The key includes the key body 111 and the three-dimensional character 112 in the key body 111, wherein the three-dimensional character 112 is the Arabic numerals 0˜9 or the symbols #, * or the like and is a character with irregular cylinder-shaped.

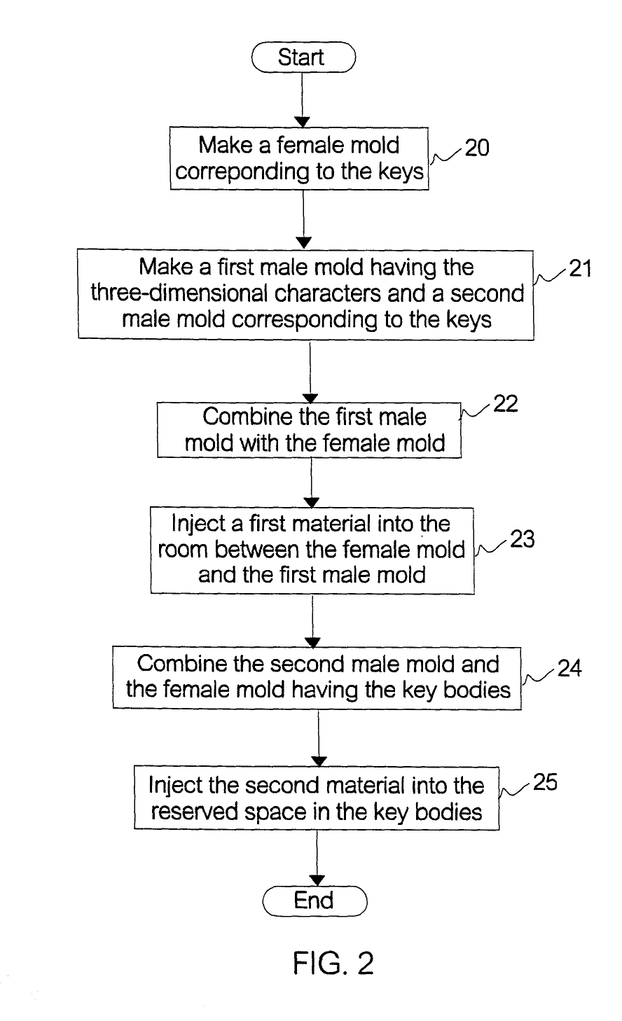

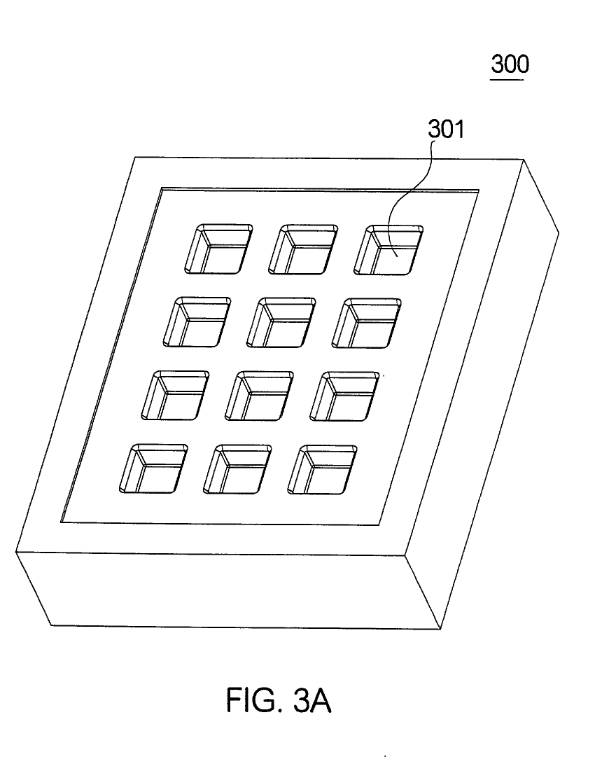

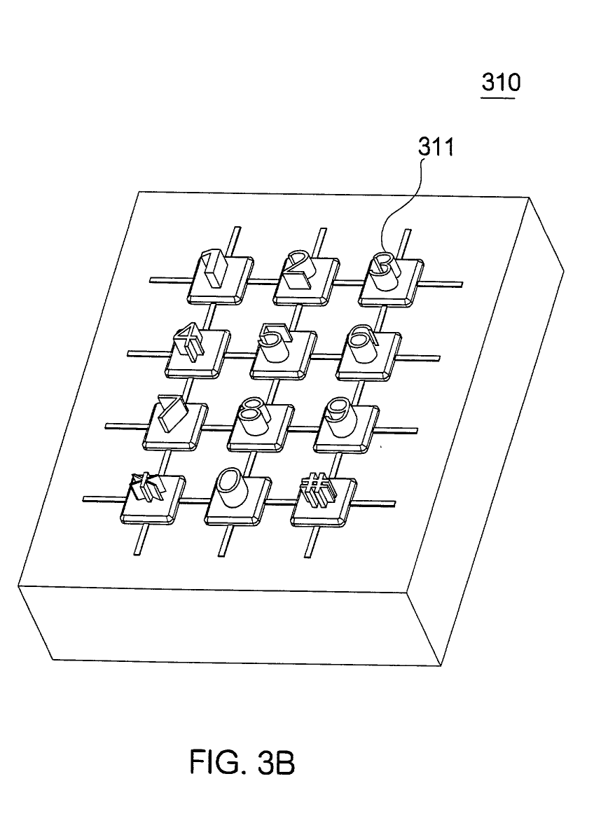

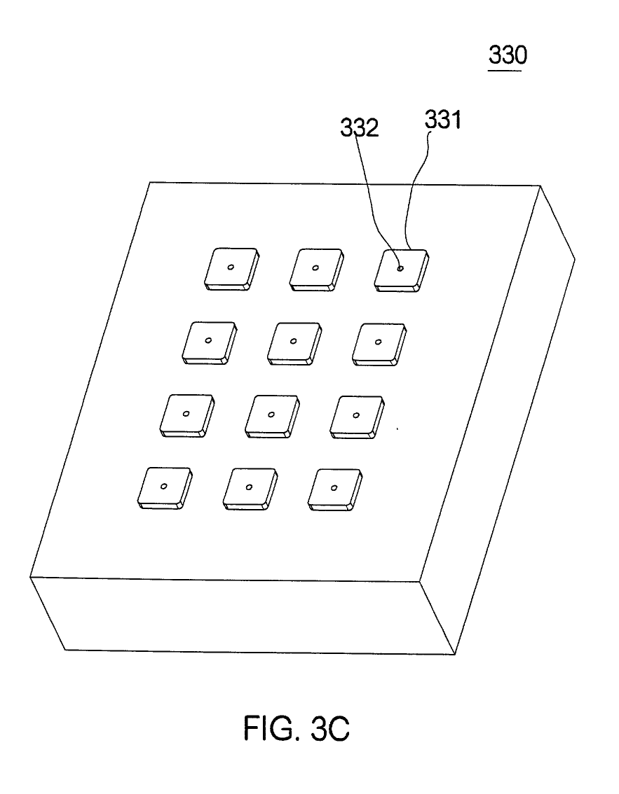

Referring to FIG. 2, which illustrates a flow chart of a method for manufacturing the keypad according to the preferred embodiment of the invention. The step 20 is first performed, the female mold 300 corresponding to the keys 110 is made. As shown in FIG. 3A, the female mold 300 for making the key bodies 111 is designed with cavities 301 arranged in accordance with the ranking of the keys 110 in FIG. 1. In the step 21, the first male mold 310 (as shown in FIG. 3B) having three-dimensional characters 311 and the second male mold 330 (as shown in FIG. 3C) corresponding to the keys 110 are made, wherein the three-dimensional characters 311 corresponding to the three-dimensional characters are irregular cylinder-shaped. The second male mold 330 has square platforms 331 and the injection holes 331 thereof, wherein the injection holes 331 are pierced inside the square platforms 331. The set of the female mold 300, first male mold 310 and second male mold 330 encompass various possibility of the quantity, size or type of the characters.

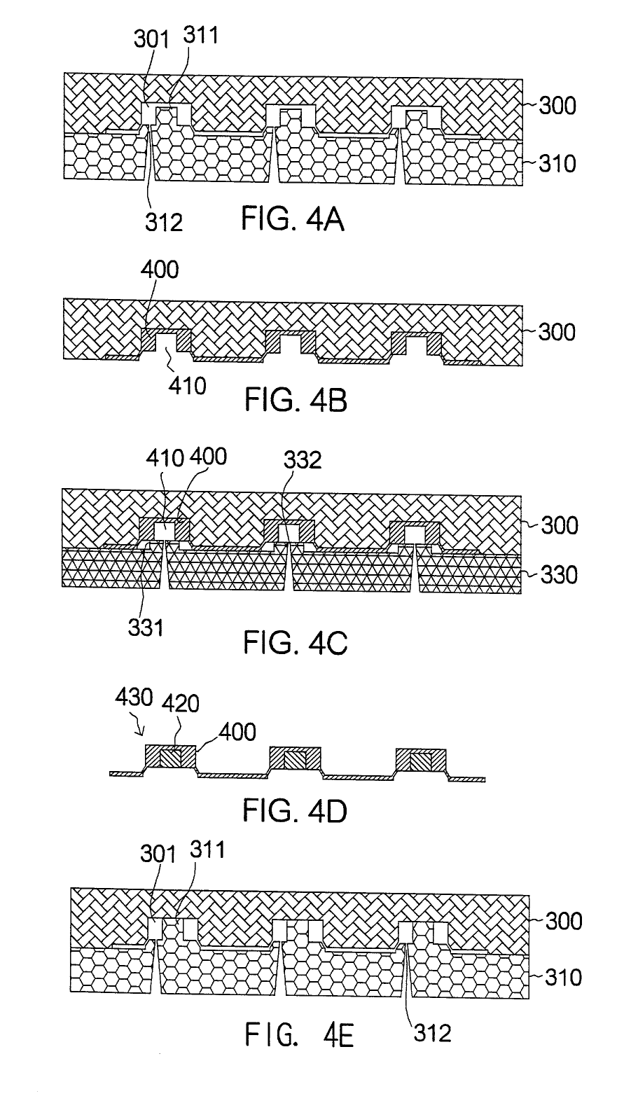

Referring next to FIGS. 4A˜4D, the cross-sectional views of the manufacturing process of the keypad according to the preferred embodiment of the invention is shown. The method proceeds to step 22, the first male mold 310 is combined with the female mold 300 as shown in FIG. 4A. The step 23 is then performed, the first material is injected in the room between the female mold 300 and the first male mold 310 to form the key body 400 and the reserved space 410 of the corresponding three-dimensional character as shown in FIG. 4B. The first material is injected into the cavity 301 of the female mold 300 from the injection hole 312 of the first male mold 310. After that, the step 24 is performed, the second male mold 330 is combined with the female mold 300 having key bodies 400 as shown in FIG. 4C, wherein the platforms 331 is tightly embedded in the second male mold 330 and joins the key bodies 400. In the final step 25, the second material is injected into the reserved space 410 of the key bodies 400 and the keys 430 having characters 420 made of the second material take shape as shown in FIG. 4D. The second material is injected into the female mold 300 from the injection hole 332 of the second male mold 330.

The aforementioned first material is a colorless or light-colored transparent texture and the second material is a dark-colored transparent or opaque texture. The feature of the invention is utilizing the color contrast between the first and the second material to display the three-dimensional character 430 shown in the key body 400. The first material and the second material can be plastic, silica gel or rubber. Besides, in the FIG. 4D, the three-dimensional character 420 can be completely covered inside the key body 400. For practically implement, however, the top surface of the three-dimensional character 420 can be equal-high relative to the key body 400. That is to say, the top of the three-dimensional character 311 of the first male mold 310 is connected to the bottom of the cavity 301 of the female mold 300 in the aforementioned manufacturing process as shown in FIG. 4E. The color of the first and the second material in contrast status can be exchanged which means the key body 400 is made of dark-colored transparent or opaque texture and the three-dimensional character 420 is made of colorless or light-colored transparent texture. Combined with an illuminant, the key 430 can show the three-dimensional character 420 clearly and distinguishably while the light goes through the transparent three-dimensional character 420. It enables the keys 430 to be visible not only in the daytime but also in the nighttime or insufficient light conditions.

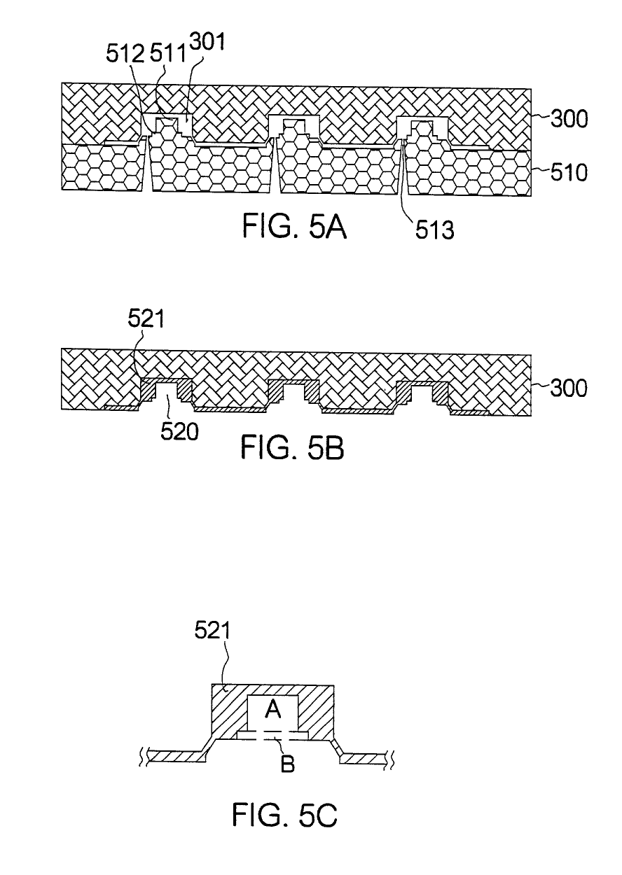

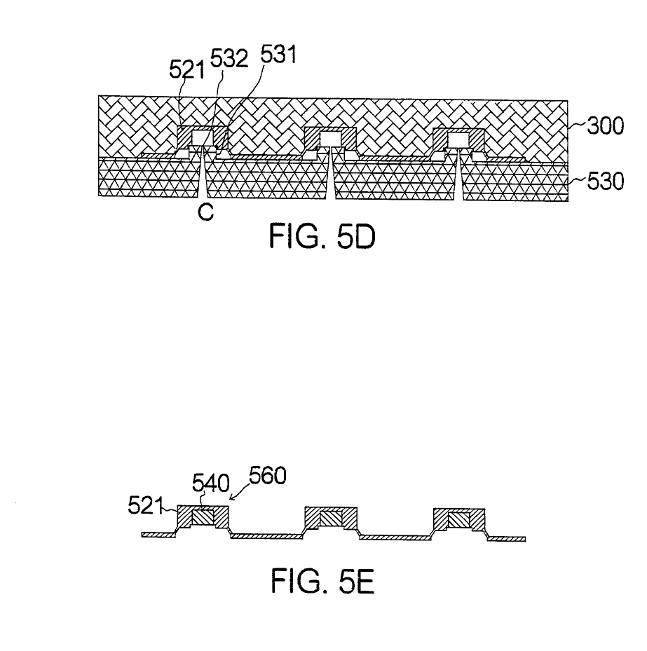

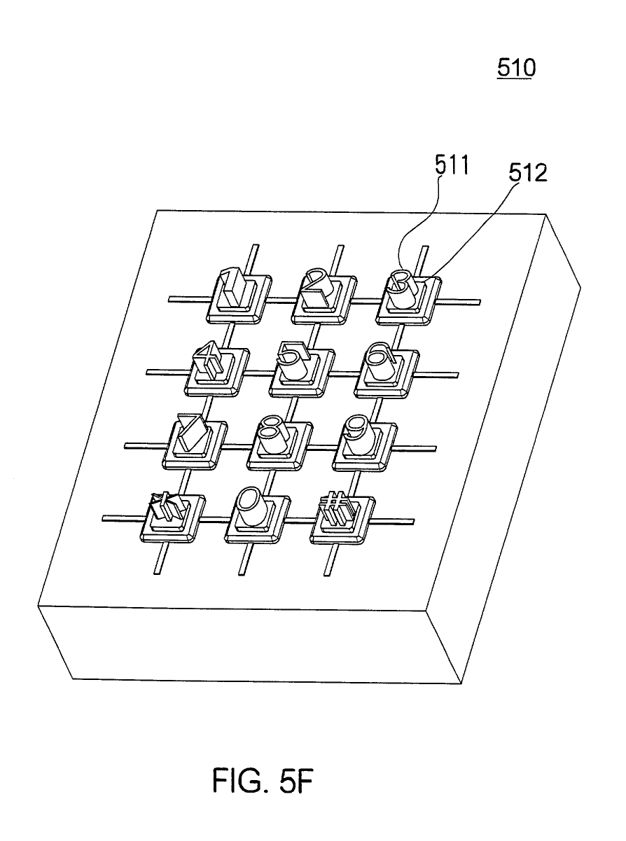

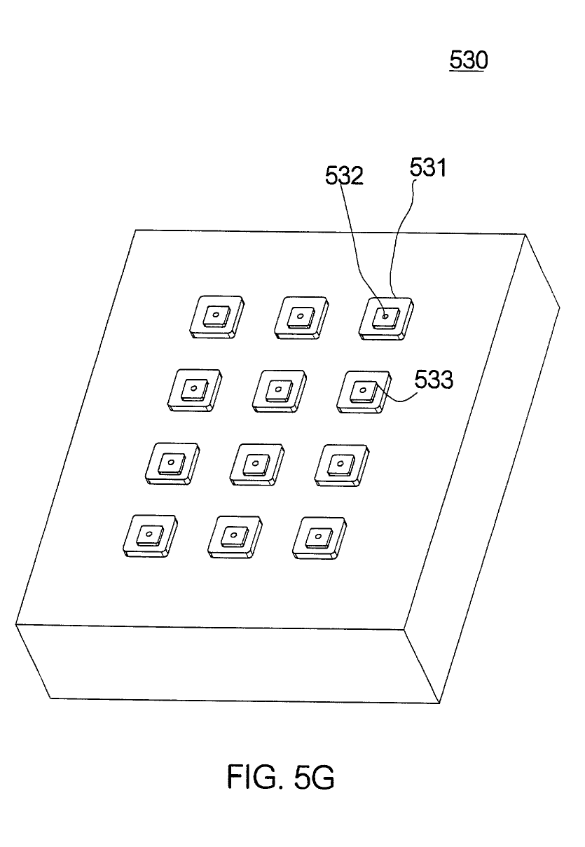

Referring to FIG. 5A˜5E, the cross-sectional views of another manufacturing process of the keypad according to the embodiment of the invention are shown. As stated-above, in the step 21, the first male mold 510 (as shown in FIG. 5F) having three-dimensional characters 511 and seats 512 and the second male mold 530 (as shown in FIG. 5G) having square platforms 531, 533 and injection holes 532 are made. The size of the square platform 533 is slightly smaller than that of the seat 512. The method proceeds to step 22, the first male mold 510 is combined with the female mold 300 as shown in FIG. 5A. The step 23 is then performed, the first material is injected into the room between the female mold 300 and the first male mold 510 to form the key body 521 and the reserved space 520 as shown in FIG. 5B. The first material is injected into the cavity 301 of the female mold 300 from the injection hole 512 of the first male mold 510. The reserved space 520 further includes the space A corresponding to the three-dimensional characters 511 and the space B corresponding to the square platform 512 as shown in FIG. 5C. The step 24 is performed, the second male mold 530 is combined with the female mold 300 having key bodies 521 and the square platform 533 is tightly wedged in the space B as shown in FIG. 5D. The set of the female mold 300, first male mold 510 and second male mold 530 encompass various possibility of the quantity, size or type of the characters. In the step 25, the second material is injected into the space A of the key body 521 from the injection hole 532 and the key 560 having character 540 made of the second material takes shape as shown in FIG. 5E. The space B is used for disposed the Light Emitting Diode (LED) which provides the light source to display the three-dimensional characters.

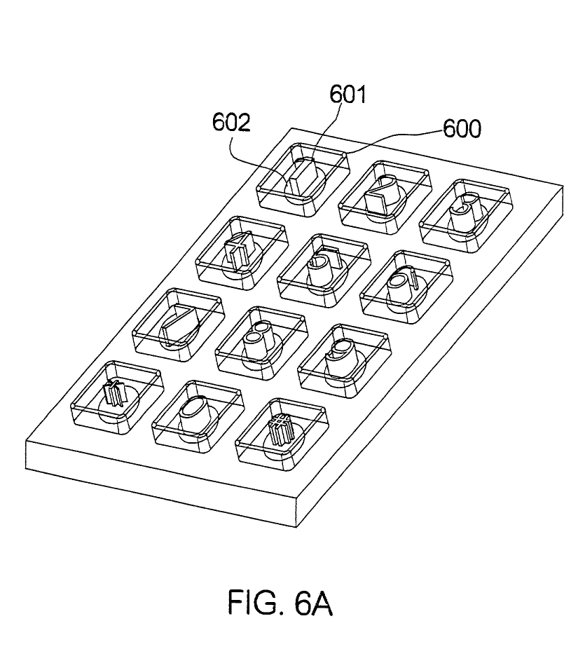

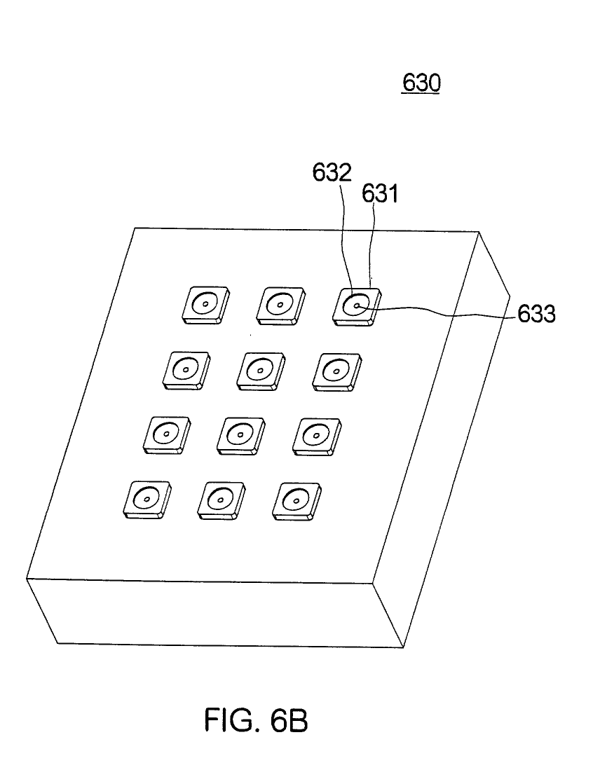

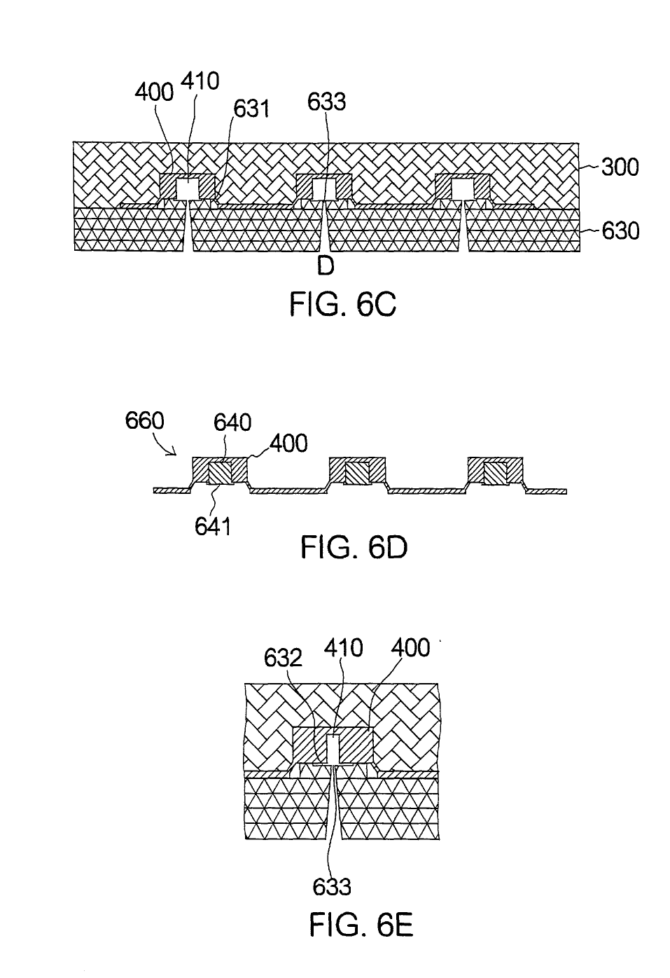

Furthermore, the width of the reserved space 410 (i.e. the width of the three-dimensional character 112) is merely 1 mm. In order to prevent the second material from failing to be injected into the reserved space 410 and form the three-dimensional character, there is another design of the key structure to overcome the manufacture bottleneck. As shown in FIG. 6A, the key 600 includes a three-dimensional character 601 and a base 602, wherein the shape of the base is not restricted in the round shape.

Referring to FIGS. 6C˜6E, the cross-sectional views of the manufacturing process of the keypad of FIG. 6A are shown. As stated-above, in the step 21, the first male mold 310 and the second male mold 630 (as shown in FIG. 6B) having square platforms 631 are made, wherein the square platform 631 further includes a round cavity 632 and an injection hole. The size of the round cavity 632 is slightly smaller than that of the cavity 301. The method proceeds to the aforementioned step 22 and step 23, the female mold 300 with the key body 400 and reserved space 410 is formed. The step 24 is then performed, the second male mold 630 is combined with the female mold 300 having key bodies 400 as shown in FIG. 6C. In the final step 25, the second material is injected into the reserved space 410 of the key body 400 and the key 560 having a character 640 and a base 641 takes shape as shown in FIG. 6D. The second material is injected into the female mold 300 from the injection hole 633 of the second male mold 630.

As shown in FIG. 6E, in actually relative size, the second material can be filled into the reserved space 410 gradually through the cavity 632. With the design of the cavity 632, it can prevent the second material from failing to be injected into the reserved space 410 due to the inaccurate aiming of the injection hole 633.

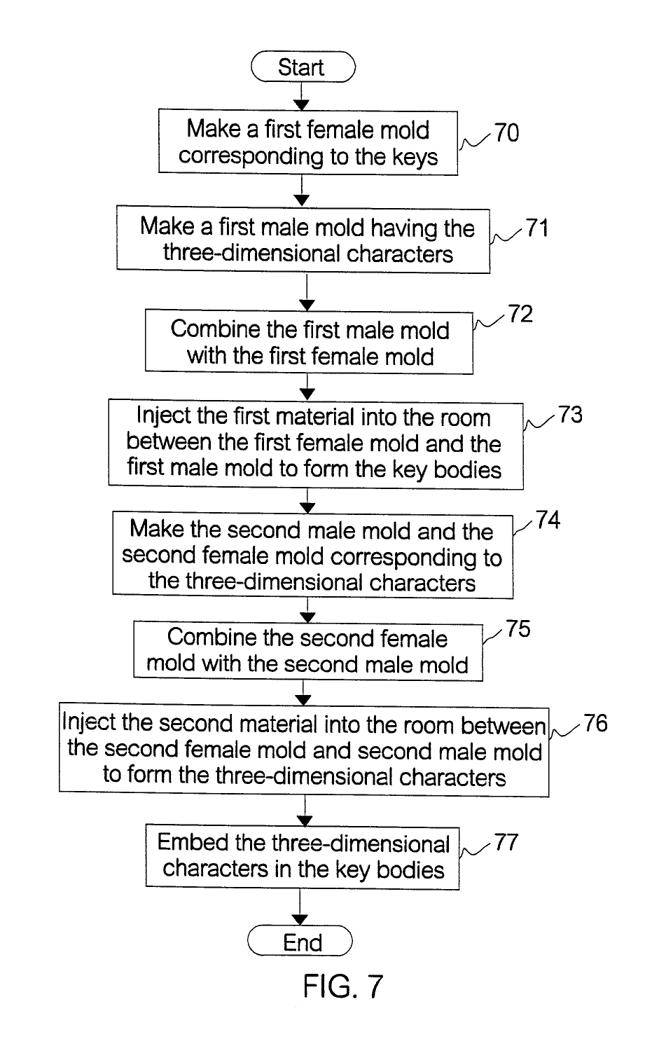

Referring to FIG. 7, a flow chart of another method for manufacturing the keypad according the preferred embodiment of the invention is illustrated. Take the keypad structure of FIG. 1 for example, the procedure of manufacture is as follows: in step 70, the first female mold 300a (the same as the female mold 300). The step 71 is performed, the first male mold 310 (as shown in FIG. 4A) with three-dimensional characters 311 is made. In step 72, the first male mold 310 is combined with the first female mold 300a. In step 73, the first material is injected into the room between the first female mold 300a and the first male mold 310 to form the key body 400 and the reserved space 410 as shown in FIG. 4B.

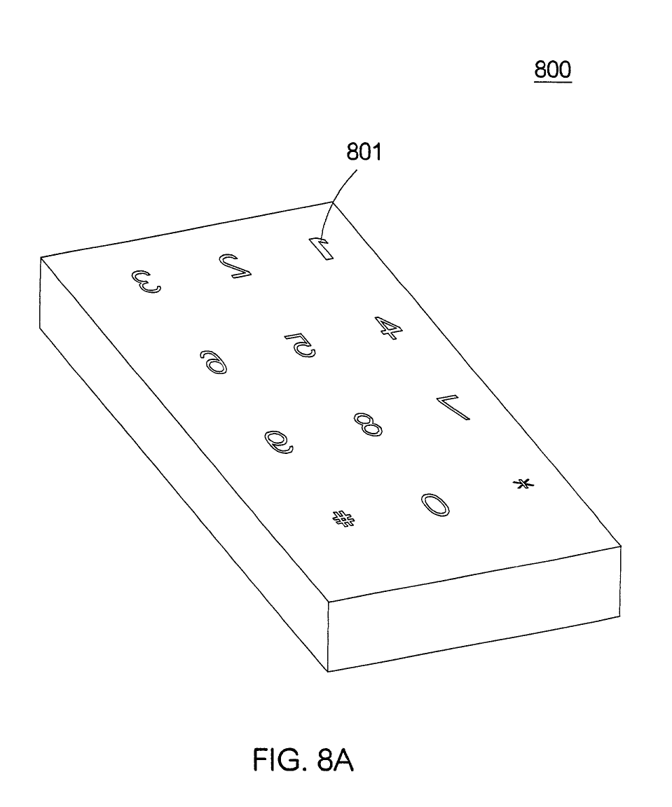

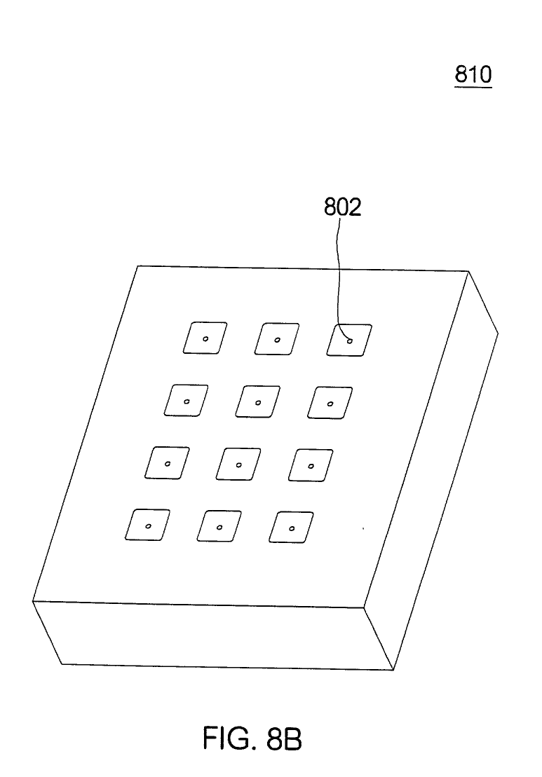

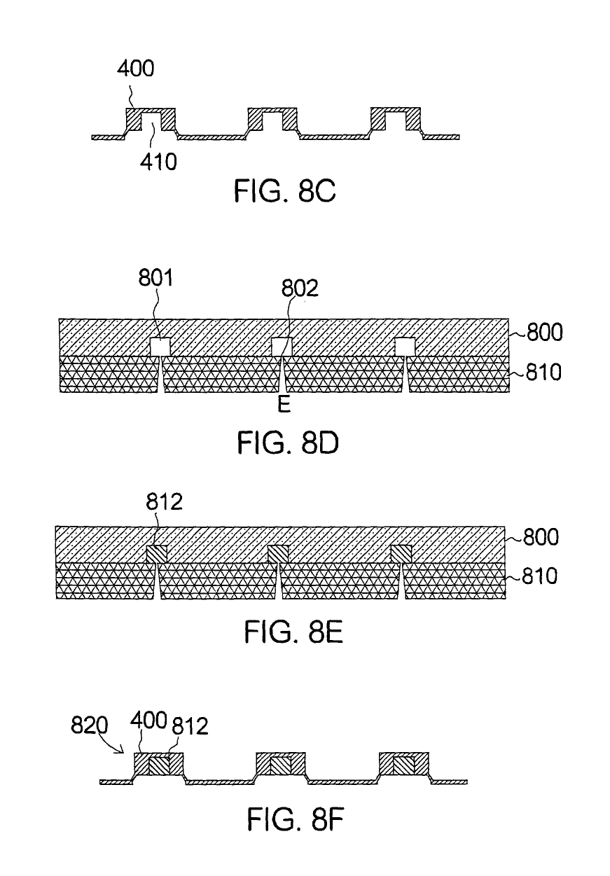

The step 74 is performed, the second female mold 800 and the second male mold 810 corresponding to the three-dimensional characters are made. As shown in FIGS. 8A and 8B, the second female mold 800 includes the cavities 801 capable of containing three-dimensional characters 112 while the second male mold 810 includes the injection holes 802 arranged in accordance with the corresponding keys. The step 75 is then performed, the second female mold 800 is combined with the second male mold 810 as shown in FIG. 8D. In step 76, the second material is injected into the room between the second female mold 800 and the second male mold 810 to form the three-dimensional characters 812 as shown in 8E. The second material is injected into the cavity 801 from the injection holes 802 of the male mold 810. In the final step 77, the three-dimensional character 812 is embedded in the key body 400 by hand or machines to form the key 820 as shown in FIG. 8F. The first material can be the aforementioned plastic, silica gel or rubber. The second material is solid plastic that the three-dimensional character 812 can be embedded in the key body 400 without damage.

The method of manufacturing a keypad according to the invention overcomes the bottleneck of the conventional techniques. It can directly inject the three-dimensional character into the transparent key body by utilizing the brand-new shaping equipment or embed the three-dimensional character in the transparent key body by hand or machines to produce the illuminated key with three-dimensional character which is bright and dazzling. All the molds for It enables the key thereof to be visible not only in the daytime but also in the nighttime or insufficient light conditions and enhances the attractiveness and practicability of the product with a keypad such like the communication devices, terminal equipment or other appliances.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for manufacturing a keypad, wherein the keypad having at least a key and the key includes a key body and a three-dimensional character, the method comprising the steps of
making a female mold corresponding to the key;
making a first male mold having the three-dimensional characters and a second male mold corresponding to the key;
combining the first male mold with the female mold;
injecting a first material into the female mold to form the key body, wherein a reserved space corresponding to the three-dimensional character is within the key body;
combining the second male mold with the female mold having the key body; and
injecting a second material into the first reserved space to form the key.

2. The method for manufacturing a keypad according to claim 1, wherein the first material is a light-colored transparent texture and the second material is a dark-colored transparent texture.

3. The method for manufacturing a keypad according to claim 1, wherein the first material is a transparent texture and the second material is an opaque texture.

4. The method for manufacturing a keypad according to claim 1, wherein the female mold comprises a first cavity for making the key body.

5. The method for manufacturing a keypad according to claim 4, wherein the top of the three-dimensional character of the first male mold is connected to the bottom of the first cavity.

6. The method for manufacturing a keypad according to claim 5, wherein the first material is a dark-colored transparent texture and the second material is a light-colored transparent texture.

7. The method for manufacturing a keypad according to claim 4, wherein the second male mold comprises:
a platform for tightly joining the key body in the first cavity; and
an injection hole, pierced inside the platform, for injecting the second material.

8. The method for manufacturing a keypad according to claim 4, wherein the first male mold further comprises a seat under the three-dimensional character.

9. The method for manufacturing a keypad according to claim 8, wherein the step of injecting the first material into the male mold, further forming a second reserved space corresponding to the seat.

10. The method for manufacturing a keypad according to claim 9, wherein the second reserved space is capable of disposed the Light Emitting Diode (LED).

11. The method for manufacturing a keypad according to claim 4, wherein the second male mold comprises:
a platform for tightly joining the key body in the first cavity;
a cavity in the center of the platform; and
an injection hole, pierced inside the second cavity, for injecting the second material; wherein the second material is injected from the injection hole into the first cavity through the second cavity.

12. The method for manufacturing a keypad according to claim 1, wherein the three-dimensional character is numerals, alphabets or symbols.

13. The method for manufacturing a keypad according to claim 1, wherein the first material is plastic, silica gel or rubber.

14. The method for manufacturing a keypad according to claim 1, wherein the second material is plastic, silica gel or rubber.

15. A method for manufacturing a keypad, wherein the keypad having at least a key and the key includes a key body and a three-dimensional character, the method comprising the steps of:
making a first female mold corresponding to the key;
making a first male mold having the three-dimensional character;
combining the first male mold with the first male mold;
injecting a first material into the first female mold to form the key body;
making a second female mold corresponding to three-dimensional character and a second male mold;
combining the second female mold with the second male mold;
injecting a second material into the second female mold to form the three-dimensional character; and
embedding the three-dimensional character in the key body to form the key.

16. The method for manufacturing a keypad according to claim 15, wherein the first material is a light-colored transparent texture and the second material is a dark-colored texture.

17. The method for manufacturing a keypad according to claim 15, wherein the first material is a transparent texture and the second material is an opaque texture.

18. The method for manufacturing a keypad according to claim 15, wherein the first material is plastic, silica gel or rubber.

19. The method for manufacturing a keypad according to claim 1, wherein the second material is plastic.
